(19) United States
(12) Patent Application Publication
(10) Pub. No.: US 2021/0397958 A1
(43) Pub. Date: Dec. 23, 2021

(54) METHODS FOR IDENTIFICATION USING DISTRIBUTED TEMPORAL NEURAL NETS - PRACTICAL CROWD SOURCED TEMPORAL NEURAL SYSTEM

(71) Applicant: Charles Saron Knobloch, Katy, TX (US)

(72) Inventor: Charles Saron Knobloch, Katy, TX (US)

(21) Appl. No.: 17/352,613

(22) Filed: Jun. 21, 2021

Related U.S. Application Data
(60) Provisional application No. 63/041,754, filed on Jun. 19, 2020.

(51) Int. Cl. G06N 3/08; G06N 3/04

(52) U.S. Cl. CPC G06N 3/08; G06N 3/0454; G06N 3/049

(57) ABSTRACT

A network of contributing and collecting temporal state-machine neurons, the state-machine neurons manifested as a physical machine deployed on a plurality of networked computing devices. The temporal neurons adapt their firing behavior based on the temporal pattern of their received inputs, the firings of contributing neurons. The temporal neurons fire based on received inputs received within a defined temporal period. In one example, the temporal position of the inputs are adjusted, based on earlier inputs received within the defined temporal period. In one example, the temporal positions of the inputs, the firings, are progressively adjusted so as to eventually align their firings occurring within the defined temporal window. A cluster of neurons is packaged into a data structure of information on neuron connections, the delay factors to adjust the temporal positions, defined temporal period, and firing threshold information, which becomes portable for transmission and use elsewhere.

### CROSS REFERENCE OF RELATED APPLICATIONS

This present application claims the benefit of U.S. Provisional Patent Application Ser. No. 63/041,754, filed Jun. 19, 2020.

### TECHNICAL FIELD

The present invention relates to methods, apparatus, and systems for neural network processing on distributed computer systems. In a particular example, disclosed herein are machine operated temporal neural networks. In a more particular example, disclosed herein are cooperating distributed neural network clusters, more particularly, temporal neural networks. Examples of human-machine interface of neural cluster creation and arrangement are also disclosed.

### BACKGROUND OF THE INVENTION

[symbol]

### BRIEF DESCRIPTION OF THE DRAWING

FIG. 1 is a schematic view showing an example of the relative positioning between contributing temporal neurons, a collecting temporal neuron, and a successive collecting temporal neuron.

FIG. 2 is a table showing an example of a processing table for a temporal neuron.

### DETAILED DESCRIPTION OF THE INVENTION

### Section One—Basic Temporal Neural Net and K-Neurons

In one example of the invention, disclosed herein is a method and resulting computing system for creation and operation of a temporal neural network.

In one example, a temporal neuron includes an electronic circuit having components positioned and arranged to perform the functional activities of the temporal neuron. In one example, computer code configures the electronic circuits to perform the functional activities of the temporal neuron.

In one example, the subject temporal neuron: observes or otherwise receives input from external sources. In one example, these external sources include other neurons or temporal neurons. The temporal neuron produces output to send or otherwise be received by another neuron when it observes or otherwise receives inputs from a threshold number of external sources within a temporal watch period. For ease in illustration, it is said that the neuron “fires” to describe the production of output from the neuron. The received or observed inputs are said to be “firings” from other (inputting) neurons. For ease in illustration, neurons or sensors providing firings to a receiving neuron are called “contributing neurons” and neurons receiving input from sources such as contributing neurons or sensors are called “collecting neurons”.

In one example, the watch period is set on a per-input basis. In one example, there is a single watch period for the neuron. In one example, the inputs are weighted in value for achieving the threshold. In one example, the inputs are weighted in value for achieving the threshold, based on the temporal arrival time within the watch window.

In one example, upon the neuron firing, the neuron amplifies those inputs that were firing in the watch period. Upon firing, the neuron de-amplifies those not firing in the watch period. In one example, over a temporal period much longer than the watch period, input neurons or sensors not contributing to the firing of the neuron are no longer observed. Those non-contribution input neurons are in equivalence disconnected from the subject neuron.

In one example, the subject temporal neuron rewards those input neurons whose firing in the watch window (watch period) contributed to the threshold needed to fire the subject neuron. A delay factor is reduced for the input firing neurons that fired early in the watch window. Upon contributing to the threshold firing of the subject neuron multiple times, the cumulatively reduced delay factors serve to temporally align the effective firing times of the contributing firing input neurons or sensors. This has the effect of enabling a reduction in the temporal width of the watch window. This creates the unexpected result of reducing background noise of unassociated firings of other input neurons or sensors. In one example, inputting neurons that fired close to the firing of the subject neuron are temporarily desensitized. For ease in illustration, this type of subject temporal neuron is called a “K-Neuron”.

For a specific example, a K-Neuron is poised with a one millisecond watch window. In this example, the K-Neuron is receiving inputs from seven other K-Neurons, the contributing neurons. The K-Neuron is set to fire an output signal to other K-Neurons should it receive firings from three of its contributing neurons during a one millisecond watch window. Continuing with this example, firings were received from contributing neurons 1, 4, and 5 during a watch window. Other neurons fired, but not during the watch window. The K-neuron fires, acting itself as a contributing neuron, sending its firing output signal to other neurons. Continuing with this example, the K-neuron temporarily attenuates any further received signals from 1, 4, and 5. This prevents or reduces the contribution of a constantly firing neuron. The K-neuron also sees that neuron 4 was the latest contributing neuron within the watch window and neuron 1 was the earliest contributing neuron in the watch window. In this example, neuron 1 is assigned a fraction of the time-distance between the firing of neuron 4 and neuron 1, since neuron 1 was the most anticipatory firing within the watch window. Neuron 5 is also assigned a fraction of the time-distance between the firing of neuron 4 and neuron 5. Just for example, say neuron 1 is assigned 0.1 millisecond and neuron 5 is assigned a 0.05 millisecond reward (which can be though of generally as a “delay factor” or temporally advancing the effective time of firing). Continuing with the example, later in time, when either a firing is received from either neuron 1 or neuron 5, the contribution of neuron 1 is advanced in time by 0.1 millisecond, for purposes of being counted in a watch window and neuron 5 is advanced in time by 0.05 millisecond, for purposes of being counted in a watch window. If these three neurons are true signals and anticipatory of a valid firing of the K-neuron, then repeated firings will result in a close alignment in time for the firings of these three neurons. In this example, over repeated firings, the K-neuron can adapt by reducing the one millisecond watch window, enhancing the signal to noise ratio for thus neuron. However, if, say, the firing of neuron 4 is not a true and anticipatory signal for a valid firing of the K-neuron, then the repeated firings of the true and anticipatory signals of the other contributing neurons will dominate the adaptive adjustments of delay factors and watch window. In further example, the K-neuron spawns and connects a new K-neuron for receiving true and anticipatory signals from its contributing neurons, as well as its own firing signal. In further example, over a significant amount of time, as the adjustments to the delay factors stabilize, non-contributing neurons are attenuated or disconnected from the K-neuron.

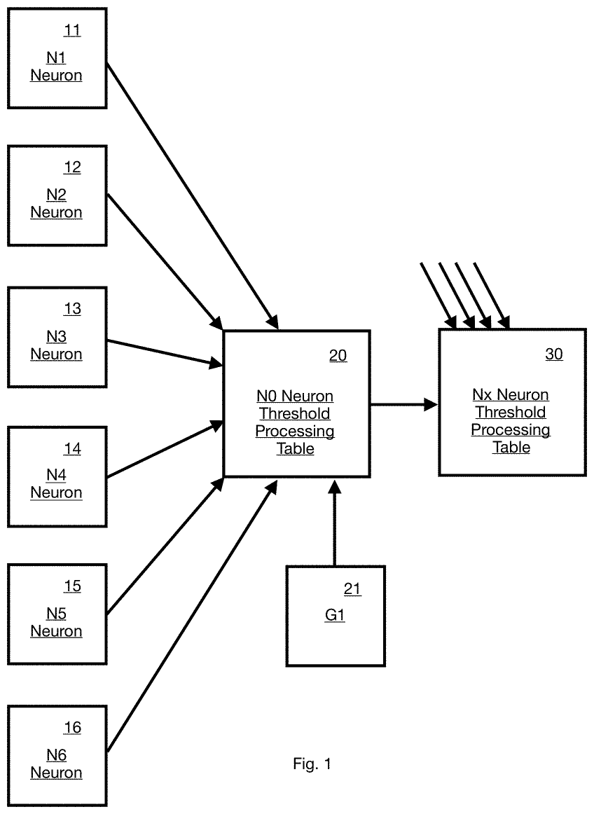

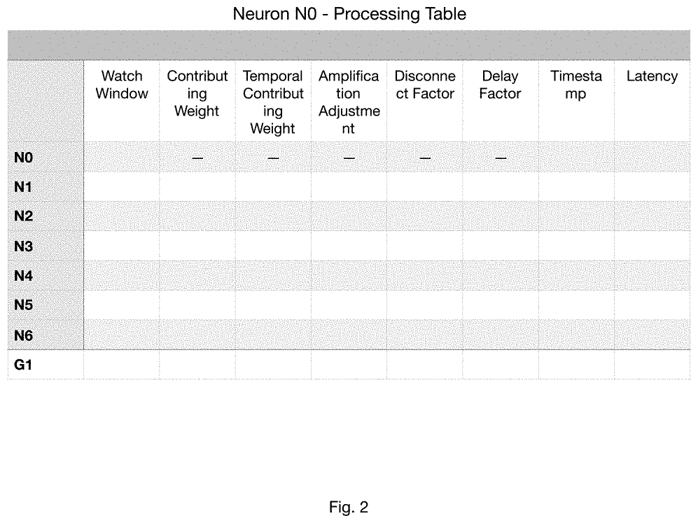

FIG. 1 is a schematic view showing an example of the relative positioning between contributing temporal neurons, a collecting temporal neuron, and a successive collecting temporal neuron. In this illustration, contributing neurons or sensors N1 through N6 are indicated by boxes 11 through 16. The firing of neurons or sensors N1 through N6 are sent to or otherwise received by neuron N0, box 20. In one example, the firings of N1 through N6 are sent to a collection heap that maintains the real time or abstracted time of firings of contributing neurons. Collecting neurons observe the heap and extract (or, collect) the neurons firing within their watch period. In one example, more than one heap is used to manage segregated clusters. Continuing with the illustration, neuron N0 maintains a threshold and a processing table. An example processing table is illustrated in FIG. 2. Should neuron N0 meet its firing criteria, a firing is sent to a collecting neuron Nx, box 30. Neuron N0 thus becomes a contributing neuron to neuron Nx. Neuron Nx, box 30 receives firings from other contributing neurons and processes its own set of firing criteria, with its own threshold and processing table. In one example, a guidance firing G1, box 21 fires to neuron N0.

FIG. 2 is a table showing an example of a processing table for a temporal neuron N0. In this example, for illustration, six contributing neurons are shown. In one example, neuron N0 has a watch window that apples generally to the firings collected. In one example, a separate watch window is defined for the firing for each neuron or sensor N1 through N6. In one example, a contributing weight is assigned to each neuron or sensor N1 through N6. In one example, the contributing weights are adjusted, based on the history of the watch window leading up to firing. In one example, a temporal contributing weight is assigned to each neuron or sensor N1 through N6. This accounts for the time within the watch window that a contributing neuron made a contribution. In one example, the contributing temporal weights are adjusted, based on the history of the watch window leading up to firing. In one example, an amplification adjustment is assigned to each neuron or sensor N1 through N6. In one example, as non-contributing patterns are experienced over multiple firings, a disconnect factor is assigned or otherwise adjusted to each neuron or sensor N1 through N6. In one example, especially in the case of k-neurons, a delay factor adjustment is made, based on the history of the neural firing within the watch window leading up to firing. In one example, the delay factor adjustments serve to align the times of firings of the neurons or sensors that are truly contributing to meet the firing threshold of neuron N0. This, in turn, serves to narrow the required overall watch window, which, in turn moves non-contributing (noise) firings out of the watch window for neuron N0. This results in an increase in the signal to noise ratio for correct firing by neuron N0. In one example, to facilitate abstraction of the temporal processing of the temporal neural clusters, a timestamp journal is maintained. In one example, a latency journal is maintained where physical latencies exist that are not associated with a contributing neuron's firing decision. In one example, the processing table includes registers for adjusting one or more guidance firing inputs G1.

In one example, a “fresh” or “new” subject temporal neuron is introduced into a collective of inputing neurons or sensors. The subject neuron receives a guidance input or inputs. This guidance input or inputs activates the firing of the subject neuron or otherwise results in providing reward to the inputting neurons or sensors that fired in the watch window (the contributing input neurons or sensors). (In one example, penalty is given to the non-contributing neurons.) In one example, the delay factor for the contributing input neurons or sensors are reduced. In one example, receipt of the guidance input or inputs are desensitized over a temporal period much longer than the watch period. In one example, the watch period is reduced as repeatedly contributing input neurons or sensors, after applying their reduced delay factors, temporally congregate to reach threshold within a shorter time window of the watch period.

It can be appreciated that the guidance input is an observation or “correlation” to be trained upon. The input neurons or sensors who are truly contributing to the firing of the subject neuron, which represents identification of the guidance input, are the signals that are thus raised from the “noise” floor of all the firing input neurons and sensors. This increase in signal to noise ratio is afforded, in the case of a K-neuron, for example, by reducing the delay factors for those contributing neurons or sensors. The non-contributing input neurons or sensors receive no reduction in delay factor (when they do not contribute during the watch window) and eventually some of them will now fall outside the watch window. In one example, the de-amplification is both temporal and in threshold contribution factor for the non-contributing input neurons or sensors. Upon multiple firing cycles, over a temporal period greater than the watch period, non-contributing input neurons or sensors are no longer watched or otherwise contribute to the subject neuron. In one example, the guidance input or inputs are reduced or eliminated from the firing process of the subject neuron.

In one example, the guidance input or inputs are provided by human intervention. For example, a human connects a guidance input mechanism to the subject neuron or manually sends a guidance input to the subject neuron. The subject neuron then observes those inputting neurons or sensors that fired during the subject neuron's watch window. The reward and penalty adjustments are then performed on or by the subject neuron.

An unexpected result, it may not be known what events (coming as firings from the input neuron or sensors) are temporally associated as prophetic to the guidance signal. Yet, the subject neuron becomes itself a lighthouse to fire when those prophetic firings occur. In one example, these lighthouse neurons are not previously named or not previously recognized by humans.

Thus it is possible to take a collective of inputing neurons or sensors and one or more “fresh” or “new” subject temporal neurons who “passively” observe the noise of the firings of the collective of inputing neurons or sensors. In one example, each “new” subject neuron watches some subset of the collective inputting neurons or sensors. As time goes on, some of the “new” subject temporal neurons will fire as their threshold is exceeded within their time window by the inputting neurons they are watching. In one example, their firings serve as guidance input to other neurons. Over time, over multiple firing cycles, the signal to noise ratio of the subject neurons increases and becomes more discriminating of correlative events being experienced by the inputting neurons. Since the sequence of firings of multiple cascades of neurons, including feedback loops, is complex in both time and space (perhaps akin to a 4-D version of a bowl of spaghetti), individual firing patterns and neural connections will not necessarily have an obvious real-world identification. This would be especially true in using a temporal neural net to reproduce a video stream or motion picture.

In one example, it can be appreciated that the temporal aspect of the interactions between the subject neuron and inputting neurons or sensors is abstracted through the use of temporal timestamps of the firings. In this way, for example, a temporal neural network running at an effective rate of 1100 Hertz can be simulated in a hyper-real time on a computer effecting the firings at say an effective rate of 1 Megahertz. Conversely, where the temporal neural net includes neural clusters scattered around the world, there will be delays in receipt of firings from inputs which are not due to the phenomenon being recognized by the neurons. Thus, the use of timestamps, relative timestamps, serve as a basis for discrimination of firings in a watch period and of firings of the neuron.

In one example, as will be disclosed by example herein, a firing neuron or its associated subscription information also provides information as to its period of temporal relevance. For example, a validity period is also associated with a neuron that fires a stock purchase signal, such as a validity period of one day, or one hour, or one minute, etc. In one example, this is combined with, or used as, the watch period of the receiving neuron.

### Section Two—Example Basic Application of a Temporal Neural Net and K-Neurons

In one example of the invention, disclosed herein is a method for identification using temporal neural net for identification of text or other sequentially presented objects.

Text is pumped through a temporal neural net (TNN), preferably a K-neural net. Each character is given a delta-T for the temporal component. For spaces between words, and sentence, and paragraph separations—possible examples would be to simply pump the space (between words), pump the period & space(s) (between sentences), pump line feed/CR and indent (between paragraphs). Another example is to assign a delta-T for each. In another example, do both. As will be seen, the identification of words, sentences, paragraphs may be identified by this process being described with a simple delta-T and the observed spaces, periods, LF/CR.

As the text is pumped through the TNN, particular neurons will fire—within a temporal window—together. A new neuron is assigned to that temporal collective and the temporal firing pattern aligned temporally, thereby weeding out which neurons and temporal spacing of the firing actually indicates the firing of the new, maturing neuron. To facilitate the maturing of the new neuron, an external neural signal(s) can be fed, representing the occurrence (presence) of the identifying event. For example, if maturing neuron(s) to recognize the end of a sentence, then an external “end of sentence” fire signal will assist in forming the temporal collective of the new neuron.

Along this aspect, another example approach is to use the external neural signal as the new neuron assignment. Thus, for example, when external “end of sentence” fire signal activates, it launches a new neuron if a new, maturing neuron does not already exist. Through timing of the maturing, and aging process of the neurons, this allows for self-healing and adaptation to longer-term changing conditions. For example, if, for some reason, “end of sentence” is no longer indicated by a period, but by an exclamation point, then the new neuron is launched and able to develop side-by-side (contemporaneously) with the neuron that detects a period.

Now, as patterns in the stream of text establish and reinforce temporal collectives, it will become evident that certain temporal collectives fire when the pattern occurs, thereby activating the matured neuron(s) for that collective. This means that a firing pattern or even a particular neuron(s) will be seen when the pattern occurs. Thus, the occurrence of a word, end of sentence, a particular word, etc will display a firing pattern or even a particular neuron(s) firing.

Now, in another example, this method can be used to recognize the language of the text. The neural net formed by text of one language will be different in some ways from the neural net formed by text of another language. Those differences can be used to identify the language of the text.

At this point, I digress to another aspect of the invention. As previously mentioned, an external neural signal can be used to facilitate the maturing of the new neuron, or in another example, to launch a new neuron if a new, maturing neuron does not already exist. This external neural signal(s) can be a previously developed neural net that developed to identify an aspect of the data being pumped. In an example, some other data or sensor input is feeding the previously developed neural net. Now, this allows for modular building of more powerful nets—and for portability of neural modules. Further, the modules can be processed in parallel or by multiple processing units. Thus, computing power can be multiplied relatively easily by scaling.

Now, to facilitate portability, another example of TNN or K-neuron can be used. In these, a time-stamp is passed in the neural firing signals, thus abstracting the temporal component. This reduces problems with delays in network traffic between neural nets or modules or portions of the neural net.

Another example of an external input is a section heading or a document classification or some document metadata. For instance, if a patent has a set of particular US Classifications, then a steady periodic firing of each of the Classifications during pumping of the patent text will assist in developing neuron(s) that recognize particular US Classifications when future documents are pumped into the neural net. By further example, individual words can become identifiable as German or English by steady periodic firing of the language as the document feeds into the net.

It can be appreciated that firing patterns of previous words or sentences that are recognized by higher order neurons will contribute to an understanding of context of the written material. For example, earlier discussion of a fish canning operation will invoke neural clusters that will provide context to a future sentence that says “I can fish.”

### Section Three—Context Sensitive Ranking of Temporal Neural Clusters

In one example of the invention, disclosed herein is a method for establishing neural structures that use context information as identifiers, enabling the same neural inputs to generate different outcomes at the same time.

To illustrate, an example is used of high grading favorite pictures by comparing two pictures at a time. In one example, an app is used as a human interface to present a “compare two” approach.

In this example, besides comparing the two pictures, or two objects, the user can decide to throw either of the pictures into a “class” or category. Similar to an album. The pictures within a class, of course, would be ranked amongst themselves.

In this example, it is possible to realize that a picture could have a higher ranking within its class than a picture that may have a higher ranking overall or in another class. This apparent duplicity is not a duplicity—as a picture may be generally appealing for a variety of reasons, but may not be the best example in the context of a particular class. In fact, the same picture in one class may be top ranked, yet low(est) ranked in another class. An example of this would be illustrated with ranking pictures of dogs (eg, “ugly dogs” class & “cute dogs” class).

Thus, introduced is the ability to have a context-sensitive ranking of objects (eg, pictures). Here, the term “context” can be used for the terms “class” and “category”.

As disclosed, this opens up the possibility of adding K-neural processing that uses the context-sensitive ranking to recognize object features. For example, a context of “blue color” or “cartoon style” may use the context sensitive ranking to use high ranking objects as exemplary for purposes of self-training. Likewise, in one example, low ranking objects are used as de-classifiers in the self-training process. In one example, higher ranking objects are fired sooner than lower ranking objects, to effect the temporal training of the neural clusters.

### Section Four—Adapting Temporal Neural Networks to Unassociated Temporal Latencies

In one example of the invention, disclosed herein is a method for compensating temporal neural networks that have latencies between neural clusters that are not associated with the context of the information being processed by the temporal neural network.

Time delay between neuron firing and receipt of firing takes into account physical limitations of the timewise distance between the neurons. For example, the firing input from a distant cluster may be in another part of the world and there may be a latency that is not associated with that firing's importance.

In one example, K-neurons address this by time stamping the firing, so that real time is abstracted away from the timing of the K-neural net.

In this improvement, information about the physical latency can also be used. It can also be used in the determination of the importance of the (remote or temporally remote) cluster. Thus, a neuron will know whether to wait (or how long to wait) before finalizing its firing decision.

So, the K-neurons can be arranged in clusters scattered on devices around the world. With latency, possibly combined with timestamps, neural clusters can form from observed firing patterns that are scattered in time, but the time further adjusted by taking into account the speed limitation of the sending cluster.

This can be illustrated with an example, using a hybrid human-machine distributed network of neural clusters. A forex trader develops a cluster that provides a “buy” signal for a particular currency. But, that cluster only provides a general signal for that day—it is not designed for hourly, minute, or second calls. Perhaps other K-neural clusters provide more frequent signals. So, the receiving cluster, when the firing signal is received, knows that the signal is good for 24 hours. The firing signal, for example, has a one hour latency not associated with its firing decision—so the signal is actually good for the next 23 hours after receipt and one hour before receipt (for determining whether the firing occurred within a watch window, for instance). The receiving cluster may get a one-hour signal from another cluster. The receiving cluster may also get a signal from another neural cluster that no major news event is happening. So, the receiving cluster decides to fire, based at least upon the inputs of these three remote clusters. Others, listening to the firing of the forex traders' receiving cluster, make their firing decisions, as appropriate.

It can be noted here, that listening to clusters can have a bit of initial and ongoing intelligent design—much like DNA coding of our initial neural network in our body.

For example, people with clusters or with their own input (sensors or human) post and advertise availability of their signals for others to subscribe. Take that trader. The trader purchases an empty cluster. The trader then signs up for signals or firings that are provided by others: for example, the daily, the hourly, and the “no news” signals. In examples, these third-party firings may be free or may carry an advertisement/info or may be for purchase or subscription purchase. The trader, satisfied that their cluster produces a useful signal, then offers their signal on a signal trading site—or uses it only to receive notifications, such as for personal use. In one example, a person could subscribe to one signal simply to get a notification when that signal has fired.

### Section Five—SQL Access to Information Held in Temporal Neural Networks

In one example of the invention, disclosed herein is use of a temporal neural network, in one example, a K-neuron temporal neural network, to store large amounts of data. Essentially, a temporal neural net generated database has been constructed. The problem with data stored or otherwise remembered by a temporal neural network is that it is not intuitive to an average user how to extract the stored or otherwise remembered information. In one example, a structured query language (SQL) interface is employed to make the temporal neural network appear as an SQL database to the information seeking users.

In one example, data invokes K-temporal neurons. Instead of traditional data base searching, submitting search criteria matches invoked neurons. This allows the “data base” to be disparate in structure, location, form—and not dependent on other portions of the database. Thus, individual data clusters become like lighthouses—or clusters of fireflies. Centralization, in form or substance, is not required.

An SQL interface can create an abstraction connection to the temporal neural net model. This allows a traditional user to access the Temporal Neural net design without needing to realize that it is not a relational database.

### Section Six—Example Practical Crowd Sourced Temporal Neural System

In one example of the invention, disclosed herein, in the narrative form, is an example of a crowd-sourced temporal neural system.

Here is an example of a more practical crowd sourced temporal neural system. In one example, a person creates one or more neurons, I am going to call them here “neural clusters”, although in public commercial application they may be called under a brand name or more appealing nomenclature. In one example, there is a neural server that the person can subscribe to or basically say “OK, I am going to create this neuron” and then this neuron will have a description and then they can basically post their neuron to one of the neural servers. For illustration, this person is called the neuron creator or neuron owner. In one example, the “neuron” represents a neural cluster.

Essentially, in a more detailed example, the neuron owner could also just have a connection where their device, the device that holds their neuron (or their cluster), just posts to a DNS-type server, so that whatever their dynamic IP address is gets trapped, so the neuron does not necessarily have to reside on a server, it can reside on their own devices, as long as people have a way to access the neurons.

So, in one example, somehow or somewhere, the owner's neurons are registered for other people to see the neuron(s), or they have to distribute the neuron(s) in some way.

Let's take an example related to temperature prediction or predicting weather or something like that. Let's do something simple, like “it's cold where I live”. Their neuron fires per the criteria established by the neuron owner. For example, a temperature sensor triggers the neuron to fire. In one example, the owner manually fires the neuron.

In one example, the owner combines information sources to dictate whether to fire the neuron, such as weather reports extracted from API calls to a weather reporting service.

Let's take an example related to buying stocks. For this narrative, let's say I am the neuron owner and I want to publish a neuron that indicates my opinion whether to buy a particular stock. For example, let's say I have a neuron that is a signal that says I think you should buy duPont stock. So, I write up what my neuron is all about and I post it. Now, on the receiving side, people can subscribe to as many neurons as they want. (In one example, the neuron can have one or both of real time signal and an artificial time signal, for instance a timestamp.)

On the receiving side, let's say I have a whole bunch of neurons that I have subscribed to and when certain events happen (that I am interested in), let's say that it was a good time to buy that stock. Let's say that I am tracking 100 different neurons and in these neurons are all kinds of information such as weather, news, whatever, somebody saying to buy or not buy, etc, etc. Let's say I determine “oh yea, today was a good day to buy stocks—then it can look at the various neurons that had fired at different times leading up to that decision point. So, for instance, maybe the pattern was that it was a cold day in Newark, anywhere from two to five days beforehand and that neuron would fire. Or, that a particular person (their neuron) would always be pretty good at firing the day before, something like that. Then, I gather that even though the various neurons may have fired at different temporal times, that if one did make an adjustment for all of them, then they would collectively lead up to a particular signal being worth sending out.

So, for instance, let's say I am gathering up all these different signals. Based on those neurons that I have been collecting, I then go ahead and post my own neuron that fires when my particular collection of neurons that I am observing fire to me. Like somebody sending out news events, an individual who happens to be pretty good at saying when to buy, or predicting the weather, or any of a broad variety of indications—when their observing patterns occur (or when they provide sensor or manual input) their neuron fires. Thus, their indication is published and observed or received by other listening neurons for those neurons to process and, in turn, fire when their observing patterns occur.

For the person or site that is monitoring a collection of neurons in real time, for example, some of the neurons feeding the new or receiving neuron will be advance indicators of the sought after event, and some will occur very close, or at, or after it is possible to make a decision that the sought after event has occurred. Once the decision has been made, then receipt of additional signals for the sought event can be suppressed so that the new neuron does not unnecessarily keep firing. For example, the advance indicators to buy a stock will trigger the new or receiving neuron. Once triggered, that new neuron should be de-sensitized for a period of time to new or additional inputs.

Also, in one example, neurons that added to the triggering are given temporal bonuses. For instance, if the watch period of the new neuron is three days, then neurons firing more than three days ago would not count towards the threshold needed to fire the new neuron.

Following with this, each external neuron (the subject neuron) in the collection has, in one example, an associated training neuron with a watch period. Neurons in the collection that are firing ahead of the subject neuron during the watch period will contribute to the firing of its training neuron.

In another example, to summarize, on firing of a neuron:
a) the neuron amplifies those firing in watch period,
b) de-amplify those not firing in the watch period,
c) desensitize the neuron (which can also include to eventually stop watching non-contributing neurons).

In one example, to summarize, a neuron has:
a) a watch period (some temporal period),
b) a firing threshold (how many fire during watch period) (in one example, can be made automatic by having a training period for the neuron where the neuron observes, amplifies, and desensitizes without firing),
c) launch of a training neuron, if applicable,
d) a desensitize period.

In one example, a watch period is assigned to each contributing neuron. For example, one watched neuron has a one hour window, while another neuron has a one day window. Thus, if a threshold number of neurons (with or without weighting) fires within their respective watch periods for that collecting neuron, then the collecting neuron will fire.

### Section Seven—Example Crowd Organized Mapping for Neural Processing

In one example of the invention, disclosed herein, in the narrative form, is an example of applying crowd organized mapping for neural processing. A search for an icon having a particular look and feel is used as a particular example.

When doing a search (let's say, looking for an icon of a calendar) there are particulars of the item that are desired, but are difficult to describe. For example, I want an icon of a calendar that is black line, the line thickness not too thin and not too thick, a mostly white (not mostly black) icon, and having other particular style and features.

So, when I get the results back from the search, there will be a large number of calendar icons—but they are a mix of different features or particulars. Instead of trying to guess what additional key words to use to filter these icons—it would be great if the features appeared as a list—so that one of a couple ways could be done to more focus the search (and, to possibly bring in additional results that were not in the first batch of search results).

So, for instance, the first search results show a bunch of calendar icons. Some of the expressed attributes may include things like “thin line” or “rounded corners” etc. The user could click on the expressed attributes that helps better define what the user is looking for. Another option, is to click on those in the search results that have features that the user is looking for (or, the opposite, that the user does not want—such as clicking on, and therefore grouping, examples of square corners that the user does not want). Clicking on several of the search results forms a group that may have some common desired (or undesired) feature. That group essentially forms a signaling neuron, which may be named or remain unnamed (the square corners may be a common feature of those in the group)—but as a signaling neuron, it is not always the case that there is a name associated with an observed feature or commonality. (Being unnamed is akin to a “feeling” about something.) The commonality may not necessarily be articulated.

These feature commonalities are groups that have been organized by one or more users. In practice, with a sufficient number of users, the groups organized and formed by individual users will be similar to groups organized and formed by other individual users. Additional users will accept or otherwise affirm the groups organized by others. Thus, the crowd of users will have collectively organized groups that represent feature commonalities.

As the groups are organizing (being organized by the users) and the crowd organizing is evolving, the feeding of this grouping information into temporal neural clusters transforms the crowd organizing information into a neural network. In one example, the evolving neural network feeds back into the evolving crowd organizing of groups having feature commonalities—thus suggesting groups to the users for their acceptance, affirmation, and use.

### Section Eight—Example of Poised Neurons for Memory Creation

In one example of the invention, disclosed herein is a method for using temporal neurons to recover data objects when those objects once again become relevant.

A data object, for example, is a past event, such as a news event, a news media object, or an identified image or audio or textual feature. The firing pattern for the past event is set so that the neurons will fire if additional current stimulus is received.

In one example, these memory recovery neurons are static: a set of neurons is poised to fire. In one example, this is dynamic: a sequence of neurons are repeatedly poised in succession, representing the past event. In this way, the new temporal sequence event matches or not. Note, in one example, the “repeatedly” can be simulated with the new event first initiating the succession of poising the sequence of neurons representing the past event.

When the poised neurons are triggered by the new event, then the resulting firing results in the past event, the data object, being delivered.

Thus, in one example, posting a comment (a “post”) creates a set of k-neuron firing patterns. In one example, the post may be related to a news event that will recur again (and again) over time, which has its own firing patterns. So, when the news event does recur, the post can automatically post again. Thus, a huge improvement over current social media such as “reddit” and “voat”, as it now becomes possible to have temporal management of social and political discussions.

In one example, the technique is applied to intellectual discourse, such as techniques in the exploration and extraction of oil & gas. For example, a feature in geophysical data is identified and the memory recovery neurons are associated with the identified geophysical data and, in one example, also commentary from an expert(s) on the implications of the identified geophysical feature. Thus, the machine-observed recurrence of the identified feature invokes access to one or more data objects that are relevant to that feature. These data objects, for example, include one or more of chat room or discussion board, other geoscience analogues, access to the training set data used in forming the identified data and memory recovery neurons, book or e-book offerings, subject matter expert directory, training videos, relevant analysis software, additional neural clusters to use, etc. These data objects, for example, serve to assist the explorationist or intellectual in providing access to additional resources that are directly associated with the recurrence of the identified feature.

### Section Nine—Example of Hardware Implementation of Temporal Neural Clusters in Memory Addressable Format

A temporal neuron has a relatively small instruction set and memory register requirement. Examples of these requirements have been disclosed, herein. A large number of temporal neurons at a high spatial density can be placed in and on a microelectronic device substrate (a “wafer”) and other nano-structures. Besides reducing space and power requirements, a few other surprising results occur. One result is the dramatic reduction in microelectronic circuitry required that would otherwise be committed, but underutilized. Instead of using the massive overhead of an operating system and complex CPU or GPU, the temporal neurons, laid in hardware internally, operate independent of operating system, CPU, GPU. This enables a collection of temporal neurons to exist as a discrete hardware component whose operation is independent of the type of operating system and other hardware components. Thus, general purpose discrete packaging becomes possible and practical. The temporal neurons are able to be independently deposited into an area of a shared substrate. This allows for widespread dissemination of neural clusters at all scales for either public or proprietary use. Thus, demand is greatly reduced on, or for, a multi-core, multi-thread CPU/GPU with massive Operating System overhead, as most internal neuron management and firing coordination is handled by the hardware neurons. This leads to another surprising result in effective CPU speed. A substrate with 10,000 neurons, for example, even operating nominally at only 1,000,000 firings per second, provides an effective CPU speed of 10 GHz, or more. Yet, the actual power consumption and total computations over a CPU doing the work is dramatically less.

In one example, neurons are addressable, simulating RAM memory. In one example, neurons appear as addressable memory to the CPU, operating system. Configuration commands and information are sent to the neuron as data for that address (eg., one byte, four bytes—32 bit, eight bytes—64 bit). In one example, configuration information is likewise retrieved as data at that address.

In one example, disclosed is a method for processing information, the method including:receiving input from one or more external sources; and if input is received from a threshold number of external sources, sending information. In further example, if the threshold number of sources is reached before expiration of a watch period, the information is sent. In further example, if the threshold number of sources is not reached before expiration of a watch period, the information is not sent. In further example, upon or after the threshold number of sources is reached, reducing a delay factor for each of the one or more external sources that provided input during the watch period. A delay factor, in one example, is used as a general term to describe recognizing the effective time that an input occurred to be closer to the time at which the threshold was reached. In further example, upon or after the threshold number of sources is reached, repeated input received from each external source having provided input during the watch period is attenuated for a transient period of time. In further example, the watch period is abstracted by receiving a timestamp with the received input. In further example, a timestamp is sent with the sending information.

In one example, disclosed is a method for processing information, the method including: receiving inputs from a plurality of external sources; identifying a temporal position for each of the received inputs; applying a transient attenuation factor to each of the received inputs; applying a delay factor to each of the identified temporal positions of the received inputs; accumulating a value, within a defined temporal period, from the attenuated received inputs at their delay factor adjusted identified temporal positions that are occurring within the defined temporal period, the value based on each of the received inputs; and sending output including temporal position information upon the accumulated value reaching or exceeding a threshold value; and wherein, upon reaching or exceeding the threshold value, adjusting the delay factor to apply for each of the inputs that contributed to reaching or exceeding the threshold value; and wherein, upon reaching or exceeding threshold value, transiently providing an attenuation factor for each of the inputs that contributed to reaching or exceeding the threshold value. In further example, outputs from the practice of the method are used as inputs to additional practices of the method. In further example, the method is adapted to provide a memory for storage of information. In further example, the memory for storage of information is adapted to store one or more of: text, an image, a stream of audio, a stream of video.

In one example, disclosed is a portable data package manifested on digital media storage devices, the portable data package holding a collection of input and output connections and respective delay factors, representing a cluster or network of temporal neurons.

### INDUSTRIAL APPLICABILITY

It can be appreciated, from the disclosures herein, that a multitude of industrial applications exist for deployment of the present invention. In one example, the temporal neurons and neural clusters are programed into a computing device. In one example, temporal neural clusters are packaged into electronic file format for sales, licensing, trading, or distribution. In one example, neural clusters are connected via computer networks, such as through the internet, to interactively cooperate in performing decision making tasks. In one example, a number of temporal neurons are placed at a high spatial density in and on a microelectronic device substrate (a “wafer”) and other nano-structures.

### CONCLUSION

Thus, in one example, disclosed is a network of contributing and collecting temporal state-machine neurons, the state-machine neurons manifested as a physical machine deployed on a plurality of networked computing devices. The temporal neurons adapt their firing behavior based on the temporal pattern of their received inputs, the firings of contributing neurons. The temporal neurons fire based on received inputs received within a defined temporal period. In one example, the temporal position of the inputs are adjusted, based on earlier inputs received within the defined temporal period. In one example, the temporal positions of the inputs, the firings, are progressively adjusted so as to eventually align their firings occurring within the defined temporal window. A cluster of neurons is packaged into a data structure of information on neuron connections, the delay factors to adjust the temporal positions, defined temporal period, and firing threshold information, which becomes portable for transmission and use elsewhere.

Although the present invention is described herein with reference to a specific preferred embodiment(s), many modifications and variations therein will readily occur to those with ordinary skill in the art. Accordingly, all such variations and modifications are included within the intended scope of the present invention as defined by the reference numerals used.

From the description contained herein, the features of any of the examples, especially as set forth in the claims, can be combined with each other in any meaningful manner to form further examples and/or embodiments.

The foregoing description is presented for purposes of illustration and description, and is not intended to limit the invention to the forms disclosed herein. Consequently, variations and modifications commensurate with the above teachings and the teaching of the relevant art are within the spirit of the invention. Such variations will readily suggest themselves to those skilled in the relevant structural or mechanical art. Further, the embodiments described are also intended to enable others skilled in the art to utilize the invention and such or other embodiments and with various modifications required by the particular applications or uses of the invention.

I claim:

1. A method for processing information, comprising:
receiving input from one or more external sources; and
if input is received from a threshold number of external sources, sending information.

2. The method of claim 1, wherein if the threshold number of sources is reached before expiration of a watch period, the information is sent.

3. The method of claim 1, wherein if the threshold number of sources is not reached before expiration of a watch period, the information is not sent.

4. The method of claim 2 wherein, upon or after the threshold number of sources is reached, reducing a delay factor for each of the one or more external sources that provided input during the watch period.

5. The method of claim 4 wherein, upon or after the threshold number of sources is reached, repeated input received from each external source having provided input during the watch period is attenuated for a transient period of time.

6. The method of claim 5 wherein the watch period is abstracted by receiving a timestamp with the received input.

7. The method of claim 6 wherein a timestamp is sent with the sending information.

8. A method for processing information, comprising:
receiving inputs from a plurality of external sources;
identifying a temporal position for each of the received inputs;
applying a transient attenuation factor to each of the received inputs;
applying a delay factor to each of the identified temporal positions of the received inputs;
accumulating a value, within a defined temporal period, from the attenuated received inputs at their delay factor adjusted identified temporal positions that are occurring within the defined temporal period, the value based on each of the received inputs; and
sending output including temporal position information upon the accumulated value reaching or exceeding a threshold value; and
wherein, upon reaching or exceeding the threshold value, adjusting the delay factor to apply for each of the inputs that contributed to reaching or exceeding the threshold value;
wherein, upon reaching or exceeding threshold value, transiently providing an attenuation factor for each of the inputs that contributed to reaching or exceeding the threshold value.

9. The method of claim 8 wherein outputs from the practice of the method are used as inputs to additional practices of the method.

10. The method of claim 9 adapted to provide a memory for storage of information.

11. The method of claim 10 wherein the memory for storage of information is adapted to store one or more of: text, an image, a stream of audio, a stream of video.

12. A collection of input and output connections and respective delay factors, representing a network of instances of practicing the method of claim 1, adapted to form a portable data package.
